(19) United States
(12) Patent Application Publication
(10) Pub. No.: US 2005/0287314 A1
(43) Pub. Date: Dec. 29, 2005

(54) Ink-jet recording medium

(75) Inventors: Joseph Hubertus Olijve, Kaatsheuvel (NL); Bernadette Catharina Anna Maria van der Velden-Schuermans, Udenhout (NL); Akira Kase, Tilburg (NL); Yoichiro Kamiyama, Tilburg (NL); Yuzo Toda, Goirle (NL)

Correspondence Address: BANNER & WITCOFF, LTD., 28 STATE STREET, 28th FLOOR, BOSTON, MA, 02109-9601, US

(73) Assignee: Fuji Photo Film B.V., Tilburg (NL)

(21) Appl. No.: 11/149,982

(22) Filed: Jun. 10, 2005

Related U.S. Application Data
(63) Continuation of application No. PCT/NL03/00891, filed on Dec. 15, 2003.

(30) Foreign Application Priority Data
Dec. 13, 2002 (EP) 02080261.7

(51) Int. Cl. B41M 5/00

(52) U.S. Cl. 428/32.38

(57) ABSTRACT

The present invention relates to a recording medium, in particular an ink-jet recording medium of photographic quality that has excellent ink absorption speed, good drying characteristics, and a good image printing quality. According to the present invention, an ink-jet recording medium is provided, comprising a support in which a water-swellable layer is adhered, comprising gelatin and a hydrophilic polymer. The present invention is further directed to methods for obtaining such a medium.

### FIELD OF INVENTION

The present invention relates generally to a recording medium, in particular an ink-jet recording medium of photographic quality that has excellent ink absorption speed, good drying characteristics and a good image printing quality.

### BACKGROUND OF THE INVENTION

In a typical ink-jet recording or printing system, ink droplets are ejected from a nozzle at high speed towards a recording element or medium to produce an image on the medium. The ink droplets, or recording liquid, generally comprise a recording agent, such as a dye, and a relatively large amount of solvent in order to prevent clogging of the nozzle. The solvent, or carrier liquid, typically is made up of water, and organic material such as monohydric alcohols and the like. An image recorded as liquid droplets requires a receptor on which the recording liquid dries quickly without running or spreading. High quality image reproduction using ink-jet printing techniques requires receptor substrates, typically sheets of paper or opaque or transparent film, that readily absorb ink droplets while preventing droplet diffusion or migration. Good absorption of ink encourages image drying while minimizing dye migration by which good sharpness of the recorded image is obtained.

There are in general two approaches for producing ink-jet recording media with photographic quality and good drying properties.

One known approach is to provide a substrate with a porous layer, which can act as the ink-receiving layer. However, this known technique may give problems as to the gloss of the paper. In specific embodiment of the known technique of substrates provided with a porous layer, there is provided on top of the porous layer a micro porous ink-receiving layer. In this micro porous type, the micro porous film has as the primary function to absorb the ink solvent. The typical micro porous film suitable for this purpose is described inter alia in U.S. Pat. No. 4,833,172, U.S. Pat. No. 4,861,644, U.S. Pat. No. 5,326,391 and EP-A-204 778.

Another approach for producing ink-jet recording media with photographic quality and good drying properties is the so called “non-micro porous film type” as proposed in several patent publications such as EP-A-806 299 and JP-A-22 76 670. For this type of ink-jet recording medium, at least one ink receptive layer is coated on a support such as a paper or a transparent film. The ink receptive layer typically contains various proportions of water swellable binders and fillers. The proportions of these components affect the properties of the coatings, in particular ink absorption properties and the gloss quality appearance of the ink-jet media.

One of the important properties of an ink-jet receptive coating formulation is the liquid absorptivity. The majority, if not all, of the ink solvent has to be absorbed by the coating layer itself. Only when paper or cloth or cellulose is used as a support, some part of the solvent may be absorbed by the support. It is thus clear that both the binder and the filler should have a significant ability to absorb the ink solvent.

One way to improve the liquid absorption and drying rates is the use of water swellable polymers.

U.S. Pat. No. 2002/142141 discloses an image-receiving layer, which may contain at least one swellable polymer like polyvinyl alcohol. Improved performance with respect to durability, scuff resistance and image fidelity is said to be obtained.

In EP-A-875 393 a sheet for ink-jet recording is disclosed in which micro porous polysaccharide particles are provided in an ink-receiving layer comprising for example polyvinyl alcohol. The micro porous particles are said to give very good ink receptivity and also to provide good sheet feeding property in ink-jet printers.

DE-A-223 48 23, and U.S. Pat. No. 4,379,804 disclose methods in which gelatin is used in ink-receiving layers of ink-jet receiving sheets. From these documents, it has become clear that gelatin has an advantageous function for the absorption of ink solvents. The gelatin is said to improve smudge resistance, increase the definition quality give high gloss, fast water absorbing properties, easy to achieve high water resistance, and good dye fading resistance.

U.S. Pat. No. 5,804,320 discloses a receiving medium, which comprises an ink-receiving layer comprising a pigment and an alkali-process gelatin, wherein said gelatin has no sol-gel reversibility at room temperature and has an average molecular weight within the range from 50, 000 to 150, 000. High image density and resolution, sharp color tone and good ink absorptivity are obtained.

In EP-A-1 080 937 an ink-receiving sheet is described having improved glossiness by the use of polysaccharides in combination with gelatin or gelatin derivatives.

U.S. Pat. No. 5,723,211 describes an ink-jet printer-recording element comprising a substrate, a solvent absorbing gelatin layer and an ink-receiving layer. Good drying, high optical densities good water fastness and excellent off set and smut resistance is claimed.

WO-A-00/37260 describes an image-recording element with a top layer and an ink receiving layer, in which the ink-receiving layer mainly comprises gelatin with a pH at much higher or lower level than the gelatins iso-electric point (IEP) to improve drying. Through the use of the top layer, physical protection for the underlying layer, reduced tackiness and a glossy appearance is obtained.

EP-A-0 830 952 describes an ink jet recording sheet in which the ink-receiving layer contains gelatin with an IEP of 5.5 to 9.6 together with a cat-ionic and optionally a hydrophilic polymer. Water resistance and gloss is improved.

There are at least two major disadvantages to a gelatin-based coating, which are not much addressed, in the existing art. These disadvantages include curl and brittleness of the coating.

In WO-A-00/53406 the use of at least one plasticizer selected from the group comprising 2-pyrrolidone and its derivatives, or urea and its derivatives is described to overcome the curl and brittleness of this type coating

There remains a need for low cost ink-jet material, which takes advantage of the gelatin based coating to provide high gloss, good water resistance, fast ink dry time, and good dye fading resistance, but also overcomes the curl and brittleness of this type coating. It is towards fulfilling this need that the present invention is directed.

### SUMMARY OF THE INVENTION

The object of the present invention is thus to provide an inkjet recording medium having good drying properties, said recording medium more in particular being suited to produce images of photographic quality, having high gloss and excellent dye fading resistance. It is another object of the present invention to provide an ink jet recording medium with reduced brittleness at low humidity's and excellent curl behaviour.

It has been found that these objectives can be met by providing an ink-jet recording medium comprising a support and a water swellable ink receiving layer. Said ink receiving layer comprises gelatin and a hydrophilic polymer, said hydrophilic polymer having a good compatibility with gelatin, giving a homogeneous solution, meaning no phase separation. The water swellable ink receiving layer may further comprise additives and reagents to improve the ink receiving layer properties with respect to ink receptivity, strength and surface appearance. Optionally a permeable protective coating can be provided on top of said swellable layer.

The substrate used in the ink-jet-receiving sheet of the present invention includes any conventional substrate for ink-jet receiving sheet. A transparent or opaque support can be used according to its final intended use.

The gelatin used can be any gelatin known in the art; also gelatin derivatives can be used

Upon our investigations to improve the drying properties of the water swellable ink receiving layers, we found that merely using water swellable layers comprising mainly gelatin suffers from high brittleness at low humidity and bad curling behaviour, which increases processing difficulties. The curling properties can be adjusted by coating extra layers on the back side of the substrate (viz. on the side opposite to the side to which the ink receiving layers are applied), but this solution is very expensive and the brittleness at low humidity's is not solved by this. The brittleness may become so severe when the humidity drops below 30% relative humidity (RH) that the coated sheet cracks during handling. It has been described, that plasticizers like 2-pyrrolidone and its derivatives, such as hydroxyethyl pyrrolidone and N-cyclohexyl-2-pyrrolidone; and/or urea and its derivatives such as imidazolidinyl urea, diazolidinyl urea, 2-hydroxyethylethylene urea, and ethylene urea, will reduce the curl of the medium at low humidity and also improves the brittleness. Mentioned plasticisers have a good compatibility with gelatin and are water-soluble. It is known in the art, that many water-soluble polymers have a very limited compatibility with gelatin. These polymers include fully hydrolysed or partially hydrolysed polyvinyl alcohol, hydroxyethyl cellulose, methylcellulose, hydroxypropyl cellulose, polyethylene oxide, polyacrylamide, and the like. When a solution is made from the blend of gelatin and one of the above polymers, micro or macro phase separation occurs in solution and subsequently in the dried coating. The dried coating exhibits high haze, low transparency, and low gloss. Naturally, this coating is not suitable as either high gloss photo paper application or as transparent film for overhead projecting application. We have now surprisingly found, that the disadvantages mentioned in the prior art can be overcome by mixing the hydrophilic polymer in a predetermined ratio with a gelatin having a specific isoelectric point and adjusting the pH of this mixture until a homogeneous solution is obtained. The optimum pH range is dependent on the gelatin used. To the resulting homogeneous solution additives and reagents can be added to improve the ink receiving layer properties with respect to ink receptivity, strength and surface appearance. Optionally a permeable protective coating can be provided on top of said swellable layer. The resulting formulation or formulations are simultaneously or subsequently coated on a substrate. Very high coating speeds can be used compared with the speeds, which are used in applying a thick boehmite ink-receiving layer on a substrate. The coating of the resulting coated material is solidified by cooling and the resulting coated material is dried. The resulting sheet has excellent properties as ink-jet recording medium.

### DETAILED DESCRIPTION

The present invention is directed to an ink-jet recording medium comprising a support, and a water swellable ink receiving layer, adhered to said support; as well as to methods for producing such a medium and methods for printing on this medium.

The recording medium of this invention is typically produced by:
1. making a homogeneous aqueous mixture of gelatin and a water soluble polymer;
2. adjusting the pH in order to obtain a homogeneous solution;
3. optionally adding ingredients, such as pigments, surfactants, cross linking agents, plasticisers, fillers, etc. and obtain a homogeneous mixture;
4. coating this mixture on a substrate and drying the resulting coated material; and
5. optionally, applying a protective coating, preferably in the same coating process step of applying said formulation or in a separate coating step.

The homogeneous aqueous solution, which is used in the above-mentioned method comprises, apart from water, gelatin and a polymer, which is soluble in water. There is a variety of gelatins or modified gelatins, which can be used. For example: alkali-treated gelatin (cattle bone or hide gelatin) or acid-treated gelatin (pigskin, cattle/pig bone gelatin), gelatin derivatives like acetylated gelatin, phthalate gelatin quaternary ammonium modified gelatin, and the like. These gelatins can be used singly or in combination for forming the solvent-absorbing layer used in the image-recording elements of the present invention. Acid and alkali treated gelatins are preferred and more preferred are acid processed gelatins. Water soluble polymers suitable for this purpose include fully hydrolysed or partially hydrolysed polyvinyl alcohol, hydroxyethyl cellulose, methyl cellulose, hydroxypropyl cellulose, polyethylene glycol (also referred to as polyethylene oxide), polyacrylamide, and the like. Polyethylene glycol is preferred. Said hydrophilic polymers when mixed in a certain ratio with a solution of gelatin in water give a turbid solution indicative for a phase separation. When using such a turbid solution the resulting gloss and curl will be negatively influenced. The appearance of turbidity is dependent on the gelatin used, the ratio gelatin/hydrophylic polymer and the pH. It is not useful to use low amounts of hydrophilic polymer, as at low amounts, the influence on the curling is negligible. The weight ratio gelatin to hydrophilic polymer should typically be between 10:1 and 1:2. The preferred range is from 7:1 until 1:1 and more preferably 6:1 and 2:1.

As mentioned before, using said gelatin/hydrophilic polymer ratios in a water solution with a gelatin concentration between 5 wt. % and 20 wt. % will generally result in a phase separation. By adjusting the pH it is possible to obtain a homogeneous solution. There is no unique rule to determine the pH at which there is no phase separation. It is best to follow the practical approach by making the required mixture of gelatin and hydrophilic polymer in water and adding alkali or acid until a homogeneous solution is obtained. The suitable pH range mainly depends on the used gelatin and the hydrophilic polymer. It was found, that acid processed gelatins having an IEP between 6.5 and 11 give a homogeneous solution with polyethylene glycol at a pH below 4.5. For practical reasons a pH below 0 is not used, so for these acid processed gelatin/polyethylene glycol mixtures a pH range from 0 to 4.5 can be used, more preferably a pH between 4 and 1. At higher pH values the mixture may remain turbid and the phase separation can remain until a pH of 10. Above pH 10 again a clear solution is usually obtained. Although such a formulation can be used it is generally not preferred because of the extreme high pH value. An advantage of using acid processed gelatins is, that they give under mentioned conditions after coating and drying a very good gloss and dry very quickly in the ink jet application.

The other class of gelatins is the so-called alkali processed gelatins. These gelatins typically have an IEP between 4 and 6.5. Upon mixing these gelatins with a hydrophilic polymer also a turbid mixture is formed indicating a phase separation. For these gelatin/hydrophilic polymer mixtures a homogeneous solution can be obtained both by increasing and by lowering the pH. So with an alkali processed gelatin with an IEP of 5 we could obtain a homogeneous mixture with polyethylene glycol at a pH above 6.5 and a pH below 5. For these mixtures the phase separation is limited to the pH range from 5 to 6.5.

The gelatin is preferably used in a total amount of from 1 to 30 g/m², and more preferably from 2 to 20 g/m². The amount of hydrophilic polymer used in a certain formulation can be easily calculated from the indicated amount of gelatin and is typically in the range from 100 mg/m² to 40 g/m² and more preferably between 200 mg/m² and 30 g/m². When preparing the ink-jet-receiving sheet by coating a plurality of ink receiving layers, each ink-receiving layer comprises an amount of gelatin ranging from 0.5 to 10 g/m².

If desired, the gelatin can be cross-linked in the image-recording elements of the present invention in order to impart mechanical strength to the layer. This can be done by any cross-linking agent known in the art.

For gelatin, there is a vast number of known cross-linking agents—also known as hardening agents. Examples of the hardener include aldehyde compounds such as formaldehyde and glutaraldehyde, ketone compounds such as diacetyl and chloropentanedion, bis (2-chloroethylurea), 2-hydroxy-4, 6-dichloro-1,3,5-triazine, reactive halogen-containing compounds disclosed in U.S. Pat. No. 3,288,775, carbamoyl pyridinium compounds in which the pyridine ring carries a sulphate or an alkyl sulphate group disclosed in U.S. Pat. No. 4,063,952 and U.S. Pat. No. 5,529,892, divinylsulfones, and the like. These hardeners can be used singly or in combination. The amount of hardener used, preferably ranges from 0.1 to 10 g, and more preferably from 0.1 to 7 g based on 100 g of gelatin contained in the ink-receiving layer.

The homogeneous aqueous solution may further contain surfactants. Preferred examples of surfactants include anionic surfactants, amphoteric surfactants, cationic surfactants, and non-ionic surfactants.

Examples of anionic surfactants include alkylsulfocarboxylates, alpha -olefin sulfonates, polyoxyethylene alkyl ether acetates, N-acylaminoacids and salts thereof, N-acylmethyltaurine salts, alkylsulphates, polyoxyalkylether sulphates, polyoxyalkylether phosphates, rosin soap, castor oil sulphate, lauryl alcohol sulphate, alkyl phenol phosphates, alkyl phosphates, alkyl allyl sulfonates, diethylsulfosuccinates, diethylhexylsulfosuccinates, dioctylsulfosuccinates and the like.

Examples of the cationic surfactants include 2-vinylpyridine derivatives and poly-4-vinylpyridine derivatives.

Examples of the amphoteric surfactants include lauryl dimethyl aminoacetic acid betaine, 2-alkyl-N-carboxymethyl-N-hydroxyethyl imidazolinium betaine, propyldimethylaminoacetic acid betaine, polyoctyl polyaminoethyl glycine, and imidazoline derivatives.

Useful examples of non-ionic surfactants include non-ionic fluorinated surfactants and non-ionic hydrocarbon surfactants. Useful examples of non-ionic hydrocarbon surfactants include ethers, such as polyoxyethylene nonyl phenyl ether, polyoxyethylene octyl phenyl ether, polyoxyethylene dodecyl phenyl ether, polyoxyethylene alkyl allyl ethers, polyoxyethylene oleyl ethers, polyoxyethylene lauryl ethers, polyoxyethylene alkyl ethers, polyoxyalkylene alkyl ethers; esters, such as polyoxyethylene oleate, polyoxyethylene distearate, sorbitan laurate, sorbitan monostearate, sorbitan monooleate, sorbitan sesquioleate, polyoxyethylene monooleate, polyoxyethylene stearate; glycol surfactants and the like. The above-mentioned surfactants are added to the homogeneous aqueous solution in an amount ranging from 0.1 to 1000 mg/m², preferably from 0.5 to 1000 mg/m².

To the homogeneous aqueous solution the following ingredients may be added in order to improve the ink receiving layer properties with respect to ink receptivity, strength and surface appearance:
Matting agents such as titanium dioxide, zinc oxide, silica and polymeric beads such as cross linked poly (methyl methacrylate) or polystyrene beads for the purposes of contributing to the non-blocking characteristics of the recording elements used in the present invention and to control the smudge resistance thereof. These matting agents may be used alone or in combination
One ore more plasticizers, such as ethylene glycol, diethylene glycol, propylene glycol, polyethylene glycol, glycerol monomethylether, glycerol monochlorohydrin, ethylene carbonate, propylene carbonate, tetrachlorophthalic anhydride, tetrabromophthalic anhydride, urea phosphate, triphenylphosphate, glycerolmonostearate, propylene glycol monostearate, tetramethylene sulfone, N-methyl-2-pyrrolidone, N-vinyl-2-pyrrolidone, and polymer lattices with low Tg-value such as polyethylacrylate, polymethylacrylate, etc.
One or more fillers; both organic and inorganic particles can be used as fillers. Useful filler examples are represented by silica (colloidal silica), alumina or alumina hydrate (aluminaol, colloidal alumina, a cat ion aluminum oxide or its hydrate and pseudo-boehmite), a surface-processed cat ion colloidal silica, aluminum silicate, magnesium silicate, magnesium carbonate, titanium dioxide, zinc oxide, calcium carbonate, kaolin, talc, clay, zinc carbonate, satin white, diatomaceous earth, synthetic amorphous silica, aluminum hydroxide, lithopone, zeolite, magnesium hydroxide and synthetic mica. Among these inorganic fillers porous inorganic fillers are preferable such as porous synthetic silica, porous calcium carbonate and porous alumina. Useful examples of organic fillers are represented by polystyrene, polymethacrylate, polymethyl-methacrylate, elastomers, ethylene-vinyl acetate copolymers, polyesters, polyester-copolymers, polyacrylates, polyvinylethers, polyamides, polyolefin's, polysilicones, guanamine resins, polytetrafluoroethylene, elastomeric styrene-butadiene rubber (SBR), urea resins, urea-formalin resins. Such organic and inorganic fillers may be used alone or in combination.
One or more mordants. Mordants may be incorporated in the ink-receptive layer of the present invention. Such mordants are represented by cationic compounds, monomeric or polymeric, capable of complexing with the dyes used in the ink compositions. Useful examples of such mordants include quaternary ammonium block copolymers. Other suitable mordants comprise diamino alkanes, ammonium quaternary salts and quaternary acrylic copolymer latexes. Other suitable mordants are fluoro compounds, such as tetra ammonium fluoride hydrate, 2,2,2-trifluoroethylamine hydrochloride, 1-(alpha, alpha, alpha-trifluoro-m-tolyl) piperazine hydrochloride, 4-bromo-alpha, alpha, alpha -trifluoro-o-toluidine hydrochloride, difluorophenylhydrazine hydrochloride, 4-fluorobenzylamine hydrochloride, 4-fluoro-alpha, alpha-dimethylphenethylamine hydrochloride, 2-fluoroethylaminehydrochloride, 2-fluoro-1-methyl pyridinium-toluene sulfonate, 4-fluorophenethylamine hydrochloride, fluorophenylhydrazine hydrochloride, 1-(2-fluorophenyl) piperazine monohydrochloride, 1-fluoro pyridinium trifluoromethane sulfonate.
One ore more conventional additives, such as: pigments(white pigments such as titanium oxide, zinc oxide, talc, calcium carbonate and the like; blue pigments or dyes such as cobalt blue, ultramarine or phthalocyanine blue; magenta pigments or dyes such as cobalt violet, fast violet or manganese violet); biocides; pH controllers; preservatives; viscosity modifiers; dispersing agents; UV absorbing agents; brightening agents; anti-oxidants; and/or antistatic agents.

These additives may be selected from known compounds and materials in accordance with the objects to be achieved.

The above-mentioned additives (matting agents, plasticizers, fillers/pigments, mordants, conventional additives) may be added in a range of 0 to 30% by weight, based on the solid content of the water swellable ink receiving layer composition.

The particle sizes of the non water-soluble additives should not be too high, since otherwise a negative influence on the resulting surface will be obtained. The used particle size should therefore preferably be less than 10 μm, more preferably 7 μm or less. The particle size is preferably above 0.1 μm, more preferably about 1 μm or more for handling purposes.

The resulting formulation can be coated to a substrate by any method known in the art. The coating methods are for example, a curtain coating, an extrusion coating, an air-knife coating, a slide coating, a roll coating method, reverse roll coating, dip coating processes and a rod bar coating.

If desired, the water swellable ink receiving layer of the present invention containing gelatin, a hydrophilic polymer like polyethylene glycol and optionally additives, may be over coated with an ink-permeable, anti-tack protective layer, such as, for example, a layer comprising a cellulose derivative such as hydroxymethyl cellulose, hydroxyethyl cellulose, hydroxypropyl methyl cellulose and carboxymethyl cellulose. An especially preferred topcoat is hydroxypropyl methylcellulose. The topcoat layer is non-porous, but is ink-permeable and serves to improve the optical density of the images printed on the element with water-based inks. The topcoat layer also serves to protect the gelatin layer from abrasion, smudging and water damage.

The topcoat material preferably is coated onto the swellable polymer layer from water or water-alcohol solutions at a dry thickness ranging from 0.1 to 5.0 micrometers, preferably 0.5 to 2.0 micrometers. The topcoat layer may be coated in a separate operation or may be coated concurrently with the water swellable layer.

In practice, various additives may be employed in the topcoat. These additives include surface active agents which control the wetting or spreading action of the coating mixture, anti-static agents, suspending agents, particulates which control the frictional properties or act as spacers for the coated product, antioxidants, UV-stabilizers and the like.

The support used in this invention may suitably be selected from a paper, a photographic base paper, a paper coated on both sides with a polymer layer, pigment coated paper, a synthetic paper or a plastic film in which the top and back coatings are balanced in order to minimise the curl behaviour.

Examples of the material of the plastic film are polyolefin's such as polyethylene and polypropylene, vinyl copolymers such as polyvinyl acetate, polyvinyl chloride and polystyrene, polyamide such as 6,6-nylon and 6-nylon, polyesters such as polyethylene terephthalate, polyethylene-2 and 6-naphthalate and polycarbonate, and cellulose acetates such as cellulose triacetate and cellulose diacetate. Before coating the dispersion onto the substrate, the support may be subjected to a corona treatment in order to improve the adhesion between the support and the coating. Also other techniques, like plasma treatment can be used to improve the adhesion.

After drying a water swellable ink receiving layer is formed on top of the used substrate. The water swellable ink-receiving layer has a dry thickness from 1 to 50 micrometers, preferably from 5 to 25 and more preferably between 8 and 16 micrometers. If the thickness of the solvent-absorbing gelatin layer is less than 1 micrometer, adequate absorption of the solvent will not be obtained. If, on the other hand, the thickness of the solvent-absorbing gelatin layer exceeds 50 micrometers, no further increase in solvent absorptivity will be gained.

The present invention will be illustrated in detail by the following non-limiting examples.

### EXAMPLE 1

In a test tube various gelatin-polyethylene glycol (PEG) mixtures were made having a 10% concentration of gelatin. After a homogeneous mixture was obtained the pH was adjusted to the value indicated in Table 1 and the turbidity was visually evaluated. The higher the value, the severer the phase separation.

TABLE 1
Influence of pH on turbidity/phase separation of gelatin PEG mixtures.
Weight ratio gelatin/PEG 6/1. Total solid content was 10%.

| | Lime bone | | acid bone | | acid pigskin |
|---|---|---|---|---|---|
| | Turbidity/ | | Turbidity/ | | Turbidity/ |
| | phase | | phase | | phase |
| pH | separation | pH | separation | pH | separation |
| 3 | 3 | 3.3 | 2.5 | 3 | 3 |
| 4 | 3 | 4 | 3 | 4 | 3 |
| 4.3 | 4 | 4.5 | 3 | 4.5 | 3 |
| 4.5 | 5 | 4.8 | 4 | 4.8 | 4 |
| 5 | 7 | 5 | 5 | 5 | 7 |
| 5.5 | 7 | 5.9 | 7 | 6 | 7 |
| 5.7 | 6 | 6.5 | 7 | 6.6 | 7 |
| 6 | 4 | 7 | 7 | 7.8 | 7 |
| 8 | 4 | 10 | 7 | 10 | 7 |
| 9 | 4 | 10.8 | 2 | 10.8 | 7 |
| 10 | 2 | | | 11.4 | 2 |

### EXAMPLE 2

### General Method to Prepare an Ink Jet Recording Sheet

An aqueous ink receiving layer involving the following process steps prepared:
mixing a 15 g of acid processed gelatin with 85 g of water at room temperature, and leaving it for 90 minutes to allow gelatin to swell, then rising the temperature up to 60° C. to make it completely soluble by stirring,
adding biocide,
adjust pH to 5.7 by NaOH.

A photographic grade paper with polyethylene laminated (both sides) was used as a substrate. The surface was treated by corona to enhance the wettability.

Prior to applying onto the substrate, the coating liquid was adjusted with water to contain 10 wt % of gelatin.

The liquid was coated on the substrate by means of a KHand Coater, bar 150, 150 μm wet thickness. The sheet was immediately cooled down to 10° C. in order to gelify the gelatin layer. Before printing the coated sheet was conditioned at 20° C. and 65%RH for at least 24 hours.

### EXAMPLE 3

Using the same method as described in Example 2, ink jet recording sheets were made using various kinds of gelatin and various ratio's of gelatin/PEG as indicated in Table 2 below. The total solid content was 10%.

Printing Test & Dryness Evaluation of the Ink-Jet Media

The inkjet sheets were further subjected to an inkjet printing test. A standard pattern comprising the colors magenta, cyan, yellow, green, red, blue and black in 5 different densities was printed on the above mentioned substrates. The printers which were used herein were HP990cx.

Directly after printing the standard pattern, a white plain paper was overlaid on the printed sheet and a stainless steel roller with a weight of 11 kg was rolled over the white paper slowly. The drying speed of the ink-jet sheet was determined by analyzing visually the color density of the print which was transferred to the white paper. A lower density at the white paper means a better drying speed of the ink-jet solvent. The gloss was visually rated; a higher number of + means a higher gloss. The curling was evaluated by putting a print of 10/15 cm on a flat surface at room temperature and a humidity of 55% and evaluating the flatness of the print. A higher number means a more flat print.

TABLE 2
Dryness/gloss/curling properties of gelatin-PEG coatings.

| | | | |
|---|---|---|---|
| Ratio | dryness | gloss | Curling |

Acid bone(IEP: 7)/PEG

| | | | |
|---|---|---|---|
| 1/0 (100% acid bone) | −−− | +++ | −−− |
| 2/1 | ++ | +/− | +++ |
| 3/1 | ++(+) | +/− | +(+) |
| 6/1 | + | + | + |
| 12/1 | −− | ++ | −− |
| 24/1 | −−− | +++ | −− |

Acid pigskin(IEP: 9)/PEG

| | | | |
|---|---|---|---|
| 1/0 (100% acid pigskin) | −−− | +++ | −−− |
| 2/1 | ++ | +/− | + |
| 3/1 | ++ | + | ++ |
| 5/1 | + | + | + |

Scoring ranges from +++ = good to −−− = not good

All gelatin-PEG solutions described in Example 3 had of pH 3.0. pH adjustment until 4.5 (non turbid/without phase separation solutions, see Example 1) gave equal drying/gloss/curling results compared to pH 3.0. pH adjustment to 5.0 gave turbid solution, mat surface and bad curling.
pH adjustment was done with HCl.

1. An ink-jet recording medium comprising a support and a water-swellable layer adhered to said support comprising a homogeneous aqueous mixture of at least one gelatin and at least one hydrophilic polymer.

2. A medium according to claim 1, wherein said hydrophilic polymer is selected from the group consisting of fully hydrolysed or partially hydrolysed polyvinyl alcohol, hydroxyethyl cellulose, methyl cellulose, hydroxypropyl cellulose, polyethylene glycol, polyacrylamide, and mixtures thereof.

3. A medium according to claim 1, wherein said hydrophilic polymer is polyethylene glycol.

4. A medium according to claim 1, wherein said gelatin is selected from alkali-treated gelatin, acid-treated gelatin, gelatin derivatives like acetylated gelatin, phthalate gelatin, quaternary ammonium modified gelatin, and the like.

5. A medium according to claim 4, wherein the gelatin is alkali-treated gelatin or acid-treated gelatin with an iso-electric point between 4 and 11.

6. A medium according to claim 1, wherein the gelatin/hydrophilic polymer weight ratio is between 1:2 and 10:1.

7. A medium according to claim 6, wherein the gelatin/hydrophilic polymer weight ratio is between 1:1 and 7:1.

8. A medium according to claim 1 further comprising an ink-permeable protective layer on top of said water-swellable layer.

9. A medium according to claim 8, wherein said protective layer comprises hydroxypropyl methylcellulose, polyvinyl alcohol, gelatin or combinations thereof.

10. A medium according to claim 1, wherein said water-swellable layer further comprises at least one additive selected from the group consisting of fillers, colorants, colored pigments, pigment dispersants, lubricants, permeating agents, fixing agents for ink dyes, UV absorbers, anti-oxidants, dispersing agents, anti-foaming agents, leveling agents, fluidity improving agents, antiseptic agents, brightening agents, viscosity stabilizing and/or enhancing agents, pH adjusting agents, biocides, anti-mildew agents, anti-fungal agents, agents for moisture-proofing, agents for increasing the paper stiffness, and anti-static agents.

11. A medium according to claim 10, in which said additive is water insoluble and has a size of between 0.1 and 10 μm.

12. A process for producing an ink-jet recording medium comprising a support and a water-swellable layer adhered to said support, which process comprises the steps of:
preparation of an aqueous mixture of a gelatin and a hydrophilic polymer;
adjusting the pH until a homogeneous aqueous solution is obtained;
optionally adding additives to this homogeneous aqueous solution giving a homogeneous aqueous mixture; and
coating said mixture on a substrate and drying the formed coated substrate.

13. A process according to claim 12, wherein the weight ratio of gelatin/hydrophilic polymer is between 10-0.5.

14. A process according to claim 12, wherein said gelatin is a member selected from the group consisting of lime bone gelatin, acid bone gelatin, and acid pigskin.

15. A process according to claim 12, wherein the aqueous mixture further comprises up to 10 g of a hardening agent for the gelatin per 100 g of gelatin.

16. A process according to claim 12, wherein the aqueous formulation comprises a surfactant selected from the group of non-ionic surfactants, anionic surfactants, cationic surfactants, amphoteric surfactants, and mixtures thereof, wherein the amount of said surfactant in the dried, coated substrate is up to 1000 mg/m².

17. A process according to claim 16, wherein the surfactant is an anionic surfactant selected from the group consisting of alkyl aryl sulphonates, alkyl sulphate ester, sulphosuccinic acid alkyl ester, aliphatic sulphonates, and mixtures there of, preferably a cationic surfactant comprising quaternary ammonium compounds.

18. A process according to claim 12, wherein said homogeneous aqueous solution or aqueous mixture is coated on said substrate using curtain coating, extrusion coating, air-knife coating, slide coating, a roll coating method, reverse roll coating, dip coating processes, or rod bar coating and subsequently dried.

19. A medium obtainable by the process of claim 12.

20. A medium according to claim 1, wherein said support is a paper, a photographic base paper, a synthetic paper or a film substrate.

21. A medium according to claim 20, wherein said support is corona treated before coating.

22. A medium according to claim 1, wherein said water-swellable layer has a thickness between 1 and 50 μm.

23. A method of forming a permanent, precise ink-jet image comprising the step of:
providing an ink-jet recording medium as is described in claim 1, and
introducing ink-jet ink into contact with the medium in the pattern of a desired image.

24. A medium according to claim 6, wherein the gelatin/hydrophilic polymer weight ratio is between 2:1 and 6:1.

25. A medium according to claim 10, in which said additive is water insoluble and has a size of between 1 and 7 μm.

26. A process according to claim 12, wherein the weight ratio gelatin/hydrophilic polymer is between 7-1.

27. A process according to claim 12, wherein the weight ratio gelatin/hydrophilic polymer is between 6-2.

28. A process according to claim 12, wherein the pH of said gelatin selected from lime bone gelatin, acid bone gelatin, and acid pigskin is adjusted to below 4.3, to below 4.8 and to below 4.8, for lime bone gelatin, acid bone gelatin, and acid pigskin, respectively.
